(19) United States
(12) Patent Application Publication
(10) Pub. No.: US 2016/0341989 A1
(43) Pub. Date: Nov. 24, 2016

(54) DISPLAY DEVICE, OPTICAL FILM AND MANUFACTURING EQUIPMENT THEREOF

(71) Applicant: SHENZHEN CHINA STAR OPTOELECTRONICS TECHNOLOGY CO. LTD., Guangdong (CN)

(72) Inventors: Xinhui ZHONG, Shenzhen, Guangdong (CN); Yung-jui LEE, Shenzhen, Guangdong (CN)

(73) Assignee: Shenzhen China Star Optoelectronics Technology Co. Ltd., Shenzhen, Guangdong (CN)

(21) Appl. No.: 14/433,604

(22) PCT Filed: Dec. 8, 2014
(86) PCT No.: PCT/CN2014/093264

§ 371 Date: Apr. 3, 2015

(30) Foreign Application Priority Data
Nov. 26, 2014 (CN) 201410693024.X

(51) Int. Cl. G02F 1/1335; G02B 5/00; B29D 11/00

(52) U.S. Cl. CPC G02F 1/1335; B29D 11/00788; G02B 5/00; B29K 2067/003

(57) ABSTRACT

A display device, an optical film and a manufacturing equipment thereof are provided. The optical film includes an optical layer. The optical layer includes: a first light-transmissive portion having mutually parallel light incident surface and light exit surface, and second light-transmissive portions distributed in the first light-transmissive portion. The first light-transmissive portion and the second light-transmissive portions have different refractive indexes. A contact surface of each of the second light-transmissive portions with the first light-transmissive portion includes an inclined surface neither parallel nor perpendicular to the light incident surface of the first light-transmissive portion, and at least a part of light rays perpendicularly incident from the light incident surface does not strike on the inclined surface and exits from the light exit surface. By the above solution, the invention can reduce image blurriness while enlarging viewing angle.

### TECHNICAL FIELD

The invention relates to the field of display technology, and particularly to a display device, an optical film and a manufacturing equipment thereof.

### DESCRIPTION OF RELATED ART

Active-type TFT-LCD display devices in recent years have been rapidly developed and widely used, and therefore have become the mainstream display device in the current market. TFT-LCD display panels mainly are classified into three types of panels: TN/STN-type, IPS-type and VA-type. The TN-type LCD display panel is developed early and has mature manufacturing technology, and thus is widely used in small and medium-sized display devices such as personal monitors, digital photo frames and mobile phones.

Compared with the IPS-type and VA-type LCD display panels, the TN-type LCD display panel has high transmittance, mature manufacturing technology and equipment and high yield. However, the TN-type LCD display panel has a grayscale inversion problem and poor viewing angle performance, and therefore generally it needs a viewing angle compensation to enlarge the viewing angle and eliminate the grayscale inversion. In the prior art, a manner of using a compensation film to achieve viewing angle compensation has proposed, and the compensation film generally is integrated with a polarizer together for use; however, because a manufacturing process thereof is complex, for example generally using a discotic liquid crystal material to process an optical film, which would increase the cost of the polarizer.

Except for the compensation film, in the prior art, a commonly-used wide viewing angle film generally uses a scattering method to scatter collimated light rays perpendicularly exited from the LCD display panel to large-angle directions, so as to improve the wide viewing angle effect of the LCD display panel. An operation principle is shown in FIG. 1, a wide viewing angle film 10 is attached to a light exit surface of a LCD display panel 11. The wide viewing angle film 10 is a transparent film and a lot of microsphere structures 12 are filled in the transparent film 10. The microsphere structures 12 and the transparent film 10 have different refractive indexes, so that collimated light rays from the LCD display panel 11 are scattered by the microsphere structures and thereby the wide viewing angle effect is achieved. However, although the wide viewing angle film in the prior art has the effect of enlarging viewing angle, the microsphere structures in the wide viewing angle film 10 are huge in number/amount and arranged irregularly, almost all the collimated light rays from the LCD display panel are changed to non-collimated light rays by the microsphere structures and scattered out, which would easily cause a blurred image.

### SUMMARY

A technical problem primarily to be solved by the invention is to provide a display device, an optical film and a manufacturing equipment thereof, which can improve image sharpness while enlarging viewing angle.

In order to solve the technical problem, a technical solution proposed by the invention is to provide an optical film. The optical film includes an optical layer and a base layer. The optical layer includes: a first light-transmissive portion having a light incident surface and a light exit surface parallel with each other, and a plurality of second light-transmissive portions distributed in the first light-transmissive portion. The plurality of light-transmissive portions are through holes penetrating through the first light-transmissive portion and being filled with air, a hole wall of each of the through holes is an inclined surface neither parallel nor perpendicular to the light incident surface of the first light-transmissive portion, two openings of each of the through holes respectively are located on the light incident surface and the light exit surface of the first light-transmissive portion and thereby at least a part of light rays perpendicularly incident from the light incident surface passes through the through hole and exits from the light exit surface so that the at least a part of the light rays perpendicularly incident from the light incident surface does not strike on the inclined surface and exits from the light exit surface. A refractive index of the first light-transmissive portion is different from a refractive index of the air. The base layer is disposed on the light exit surface of the first light-transmissive portion, and a refractive index of the base layer is the same as the refractive index of the first light-transmissive portion.

In an embodiment, each of the through holes is a tapered through hole, the large one of the two openings of the tapered through hole is located on the light exit surface of the first light-transmissive portion, and the small one of the two openings of the tapered through hole is located on the light incident surface of the first light-transmissive portion.

In an embodiment, the refractive index of the first light-transmissive portion is greater than the refractive index of the air.

In order to solve the above technical problem, another technical solution proposed by the invention is to provide a display device. The display device includes a display screen and an optical film. The optical film includes an optical layer. The optical layer includes a first light-transmissive portion and a plurality of second light-transmissive portion. The first light-transmissive portion has a light incident surface and a light exit surface parallel with each other. The light incident surface of the first light-transmissive portion is attached to a display surface of the display screen to receive image light rays of the display screen. The plurality of second light-transmissive portions are distributed in the first light-transmissive portion. The first light-transmissive portion and the plurality of second light-transmissive portions have different refractive indexes, a contact surface of each of the plurality of second light-transmissive portions with the first light-transmissive portion includes an inclined surface neither parallel nor perpendicular to the light incident surface of the first light-transmissive portion, and at least a part of light rays perpendicularly incident from the light incident surface does not strike on the inclined surface and exits from the light exit surface.

In an embodiment, each of the plurality of second light-transmissive portions are through holes penetrating through the first light-transmissive portion and being filled with air, a hole wall of each of the through holes is the inclined surface neither parallel nor perpendicular to the light incident surface of the first light-transmissive portion, two openings of each of the through holes respectively are located on the light incident surface and the light exit surface of the first light-transmissive portion and thereby the at least a part of the light rays perpendicularly incident from the light incident surface passes through the through hole and exits from the light exit surface so that the at least a part of the light rays perpendicularly incident from the light incident surface does not strike on the inclined surface and exits from the light exit surface. The refractive index of the first light-transmissive portion is different from the refractive index of the air.

In an embodiment, each of the through holes is a tapered through hole, the large one of the two openings of the tapered through hole is located on the light exit surface of the first light-transmissive portion, and the small one of the two openings of the tapered through hole is located on the light incident surface of the first light-transmissive portion.

In an embodiment, the refractive index of the first light-transmissive portion is greater than the refractive index of the air.

In an embodiment, the optical film further includes a base layer. The base layer is disposed on the light exit surface of the first light-transmissive portion, and a refractive index of the base layer is the same as the refractive index of the first light-transmissive portion.

In order to solve the above technical problem, still another technical solution proposed by the invention is to provide a manufacturing equipment. The manufacturing equipment includes a first coating mechanism and a transferring mechanism. The first coating mechanism is configured (i.e., structured and arranged) for forming a first light-transmissive portion of an optical layer. The first light-transmissive portion includes a light incident surface and a light exit surface parallel with each other. The transferring mechanism is configured for forming a plurality of second light-transmissive portions in the first light-transmissive portion to thereby form the optical layer of the optical film. The first light-transmissive portion and the plurality of second light-transmissive portions have different refractive indexes, a contact surface of each of the plurality of second light-transmissive portions with the first light-transmissive portion includes an inclined surface neither parallel nor perpendicular to the light incident surface of the first light-transmissive portion, and at least a part of light rays perpendicularly incident from the light incident surface does not strike on the inclined surface and exits from the light exit surface.

In an embodiment, the transferring mechanism is a roller having a plurality of protrusions formed on a surface thereof. The roller is disposed behind the first coating mechanism in a transport direction of the optical layer. During the first light-transmissive portion is transported to the roller, the plurality of protrusions squeeze into the first light-transmissive portion from the light exit surface of the first light-transmissive portion and penetrate through the light incident surface of the first light-transmissive portion to form through holes having the same size and the same shape as the plurality of protrusions in the first light-transmissive portion and thereby form the plurality of second light-transmissive portions. When any one of the plurality of protrusions squeezes into the first light-transmissive portion, a contact surface of the protrusion with the first light-transmissive portion is neither parallel nor perpendicular to the light incident surface of the first light-transmissive portion.

In an embodiment, each of the plurality of protrusions is tapered, and an end of the protrusion near the surface of the roller is larger than another end of the protrusion away from the surface of the roller. During the first light-transmissive portion is transported to the roller, the small end of the protrusion squeezes into the first light-transmissive portion from the light exit surface of the first light-transmissive portion and penetrates through the light incident surface of the first light-transmissive portion.

In an embodiment, the manufacturing equipment further includes a curing mechanism and a base layer transportation mechanism. The curing mechanism is disposed behind the roller in the transport direction of the optical layer and configured for curing the optical layer. The base layer transportation mechanism is disposed behind the curing mechanism in the transport direction of the optical layer and configured for transporting a base layer of the optical film onto the light exit surface of the first light-transmissive portion to thereby form the base layer of the optical film on the light exit surface. A refractive index of the base layer is the same as the refractive index of the first light-transmissive portion.

The efficacy of the invention is that: different from the prior art, in the optical film of the invention, the first light-transmissive portion and the second light-transmissive portions have different refractive indexes and a contact surface of each second light-transmissive portion with the first light-transmissive portion includes an inclined surface neither parallel nor perpendicular to the light incident surface of the first light-transmissive, so that a part of light rays perpendicularly incident from the light incident surface is deflected on the inclined surface, the exit direction of the part of the light rays which originally perpendicularly exits from the light exit surface is changed to be non-perpendicular to the light exit surface, and therefore the purpose of enlarging viewing angle is achieved. In addition, at least a part of the light rays perpendicularly incident from the light incident surface does not strike on the inclined surface, the propagation direction of the at least a part of the light rays would not be deflected, and because the light exit surface and the light incident surface are parallel with each other, the at least a part of the light rays would perpendicularly exit from the light exit surface, and therefore it can reduce image blurriness and improve image sharpness.

### BRIEF DESCRIPTION OF THE DRAWINGS

In order to more clearly illustrate the technical solutions of various embodiments of the present invention, drawings will be used in the description of embodiments will be given a brief description below. Apparently, the drawings in the following description only are some embodiments of the invention, the ordinary skill in the art can obtain other drawings according to these illustrated drawings without creative effort. In the drawings:

FIG. 1 is a schematic structural view of a wide viewing angle film in the prior art;

FIG. 2 is a top view of an embodiment of an optical film of the invention;

FIG. 3 is a cross-sectional view of the optical film in FIG. 2 taken along the A-B direction;

FIG. 4 is a cross-sectional view of another embodiment of the optical film of the invention;

FIG. 5 is a top view of still another embodiment of the optical film of the invention;

FIG. 6 is a cross-sectional view of the optical film in FIG. 5 taken along the C-D direction;

FIG. 7 is a top view of still another embodiment of the optical film of the invention;

FIG. 8 is a top view of still another embodiment of the optical film of the invention;

FIG. 9 is a top view of still another embodiment of the optical film of the invention;

FIG. 10 is a top view of still another embodiment of the optical film of the invention;

FIG. 11 is a top view of still another embodiment of the optical film of the invention;

FIG. 12 is a cross-sectional view of still another embodiment of the optical film of the invention;

FIG. 13 is a cross-sectional view of still another embodiment of the optical film of the invention;

FIG. 14 is a cross-sectional view of still another embodiment of the optical film of the invention;

FIG. 15 is a schematic structural view of an embodiment of a display device of the invention;

FIG. 16 is a schematic structural view of an embodiment of a manufacturing equipment of an optical film of the invention;

FIG. 17 is a schematic structural view of another embodiment of the manufacturing equipment of an optical film of the invention; and

FIG. 18 is a schematic partial enlarged view of the manufacturing equipment in FIG. 17.

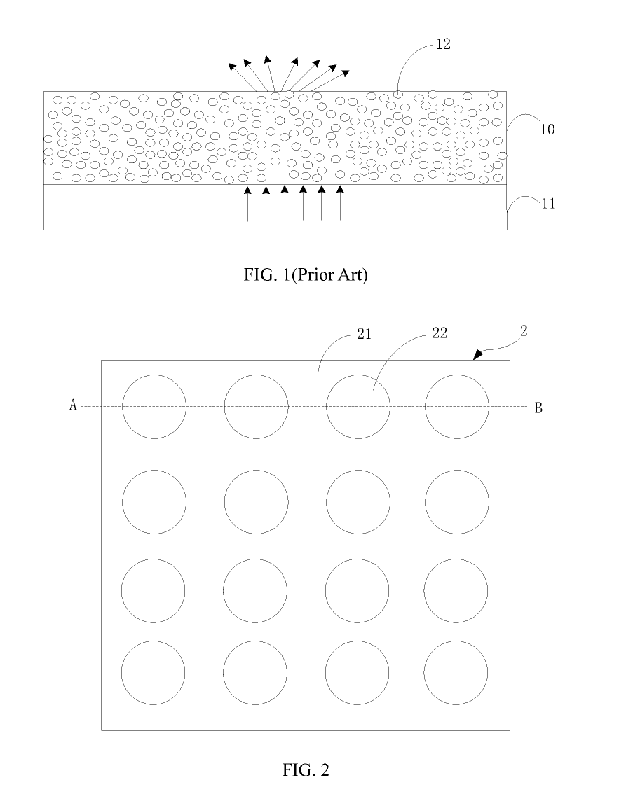

### DETAILED DESCRIPTION OF EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

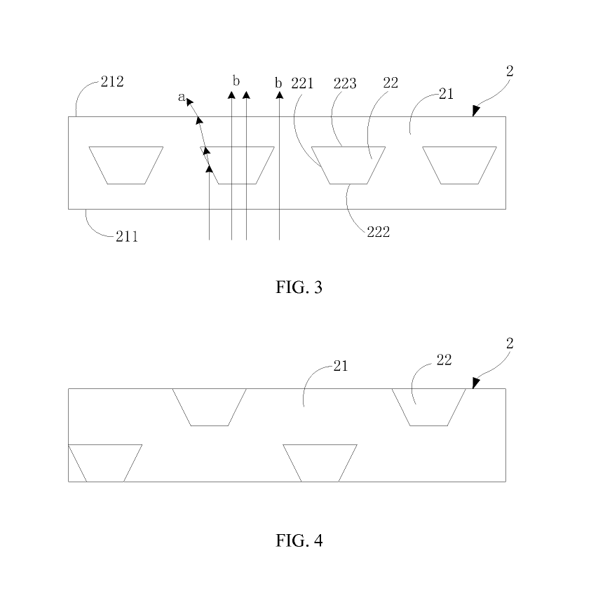

Referring to FIG. 2 and FIG. 3, FIG. 2 is a top view of an embodiment of an optical film of the invention, and FIG. 3 is a cross-sectional view of the optical film as shown in FIG. 2 taken along the dashed line AB. In this embodiment, the optical film mainly is applied to display devices and includes an optical layer 2. The optical layer 2 includes a first light-transmissive portion 21 and a plurality of second light-transmissive portions 22 distributed in the first light-transmissive portion 21.

The first light-transmissive portion 21 is a base of the optical film and made of an optically transparent organic material, for example is a PET film, TAC or an organic glass and has a thickness in the range of 5 μm˜100 μm, for example 10 μm, 25 μm or 40 μm. Of course, the thickness of the first light-transmissive portion 21 may be in other range e.g., 120 μm˜180 μm, and concretely can be set according to the actual need of product.

The first light-transmissive portion 21 has a light incident surface 211 and a light exit surface 212 parallel with each other.

The second light-transmissive portions 22 and the first light-transmissive portion 21 have different refractive indexes. The second light-transmissive portions 22 may be made of an optically transparent material having a refractive index different from that of the first light-transmissive portion 21. For example, when the first light-transmissive portion 21 is made of a PET (polyethylene terephthalate) material, the second light-transmissive portions 22 may be made of an organic glass having a refractive index different from that of the first light-transmissive portion 21. Of course, the second light-transmissive portions 22 may be air-filled pore structures.

A contact surface of each of the second light-transmissive portions 22 with the first light-transmissive portion 21 includes an inclined surfaces 221 neither parallel nor perpendicular to the light exit surface 211 or the light incident surface 212 of the first light-transmissive portion 21, as shown in FIG. 3, in this embodiment, a cross-sectional shape of each of the second light-transmissive portions 22 is trapezoid, the two upper and lower parallel surfaces of the second light-transmissive portion 22 are parallel to the light incident surface 211, the two left and right side surfaces of the second light-transmissive portion 22 are the inclined surface 221 neither parallel nor perpendicular to the light incident surface 211, and therefore light striking on the inclined surface 221 meets the condition of being refracted, the light ray a perpendicularly incident from the light incident surface 211 and striking on the inclined surface 221 would be deflected on the inclined surface 221, the light ray a which originally perpendicularly exits from the light exit surface 212 will exit from the light exit surface 212 along a direction non-perpendicular to the light exit surface 212, the exit angle of the light ray a is enlarged and the purpose of enlarging viewing angle is achieved. The exit angle is an intersection angle between a light ray exited from the light exit surface 212 and a normal line perpendicular to the light exit surface 212, and when the exit angle is 0°, the exit light ray is perpendicular to the light exit surface 212.

Each neighboring second light-transmissive portions 22 have an interval existed therebetween, so that some of light rays b perpendicularly incident from the light incident surface 211 will pass through between neighboring second light-transmissive portions 22 along the direction perpendicular to the light incident surface 211 or the light exit surface 212 and not strike on the inclined surface 221, and then perpendicularly exits from the light exit surface 212. The interval between neighboring second light-transmissive portions 22 is a region between the neighboring second light-transmissive portions and being not blocked by the inclined surface 221 in a light path that is from the light incident surface 211 to the light exit surface 212 and perpendicular to the light incident surface 211 or the light exit surface 212. By setting the arrangement manner of the second light-transmissive portions 22 in the first light-transmissive portion 21, some of the light rays b perpendicularly incident from the light incident surface 211 can directly pass though between the second light-transmissive portions 22 and does not strike on the inclined surface 221.

As shown in FIG. 2 and FIG. 3, in this embodiment, the arrangement manner of the second light-transmissive portions 22 is in a matrix form, neighboring second light-transmissive portions 22 have an interval existed therebetween, all the second light-transmissive portions 22 in the first light-transmissive portion 21 are at a same horizontal level, and there is no overlapped inclined surface 221 in the direction of perpendicular to the light incident surface 211 or the light exit surface 212, it is ensured that the interval between neighboring second light-transmissive portions 22 has no inclined surface 221 existed therein, the light path of some of the light rays b perpendicularly incident from the light incident surface 211 would not pass the inclined surface 221, and the light propagation direction of the some of the perpendicularly-incident light rays b would not be changed when passing through the interval between neighboring second light-transmissive portions 22 and it still perpendicularly exits from the light exit surface 212 along the direction perpendicular to the light exit surface 212. Accordingly, it is ensured that some of the light rays perpendicularly incident from the light incident surface 211 still can perpendicularly exit, all the perpendicularly incident light rays being deflected and then exited from different directions can be avoided, and so that it is beneficial to reduce image blurriness and improve image sharpness.

Of course, in other embodiment, as shown in FIG. 4, the second light-transmissive portions 22 in the first light-transmissive portion 21 may be not arranged at a same horizontal level, and are arranged staggered up and down. Moreover, the cross-sectional shape of each of the second light-transmissive portions 22 may be circular or elliptical and at this situation a contact surface of each of the second light-transmissive portions 22 with the first light-transmissive portion 21 overall is an inclined surface neither parallel nor perpendicular to the light incident surface 211. The arrangement manner of the second light-transmissive portions 22 may be other arrangement manner, as long as the region being not blocked by the inclined surface 221 in the light path perpendicular to the light incident surface 211 or the light exit surface 212 is existed in the first light-transmissive portion 21, so as to ensure some of the light rays perpendicularly incident from the light incident surface 211 would not strike on the inclined surface 221 and can perpendicularly exit from the light exit surface 212.

Still referring to FIG. 3, in this embodiment, the contact surface of each of the second light-transmissive portions 22 with the first light-transmissive portion 21 further include two opposite parallel surfaces 222, 223 which are parallel to the light incident surface 211 or the light exit surface 212 of the first light-transmissive portion 21, so that some of the light rays b perpendicularly incident from the light incident surface 211 can sequentially pass through the parallel surfaces 222, 223 and exit from the light exit surface 212 and do not strike on the inclined surface 221. Because the parallel surfaces 222, 223 are parallel to the light incident surface 211, the some of the light rays b perpendicularly incident from the light incident surface 211 are not deflected when passing through the parallel surfaces 222, 223, the light propagation direction thereof is not changed, and thus they can perpendicularly exit from the light exit surface 212.

Accordingly, in this embodiment, in the light rays perpendicularly incident from the light incident surface 211, only a small part a of the light rays is deflected on the inclined surface 221, most part b of the light rays do not strike on the inclined surface 221 and directly pass through the interval between neighboring second light-transmissive portions 22 and the parallel surfaces 222, 223 of second light-transmissive portion and then exit from the light exit surface 212, the exit angles of the light rays b basically is not deflected and they still exit along the direction perpendicular to the light exit surface 212, which can significantly reduce image blurriness while enlarging viewing angle. In addition, the prior art although can achieve the purpose of enlarging viewing angle by using the microsphere structures to scatter the perpendicularly-incident light rays, the microsphere structures have strong reflection and scattering to the ambient light, it is easy to observe the ambient light reflected by the microsphere structures in all directions, resulting in image whitened and low contrast. Compared with the prior art, in this embodiment, the second light-transmissive portions 22 may cause the reflection of ambient light only on the inclined surface 221, and therefore the reflection of ambient light is weak, which is beneficial to improve the contrast and reduce the phenomenon of image whitened.

Of course, in other embodiment, neighboring second light-transmissive portions may not have the interval existed therebetween, by using the two opposite parallel surfaces of each second light-transmissive portion to make some of perpendicularly incident light rays to perpendicularly exit from the light exit surface, it also can reduce image blurriness.

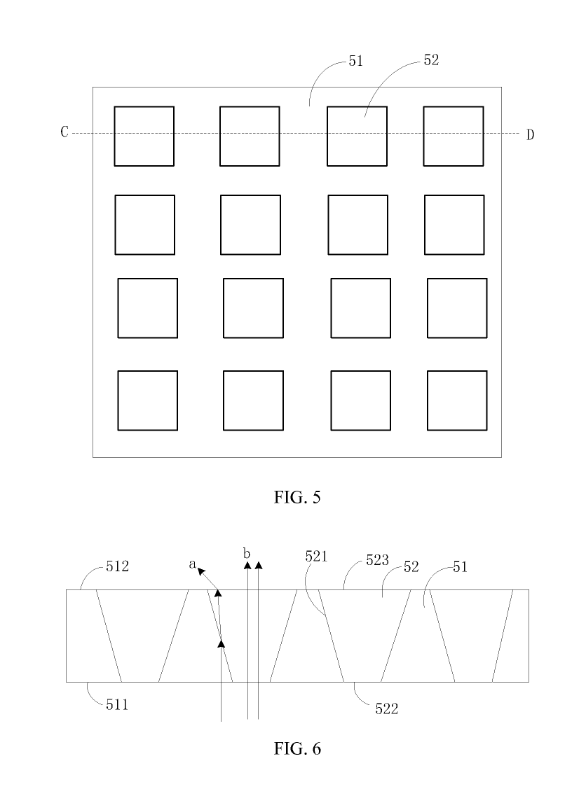

Referring to FIG. 5 and FIG. 6, in another embodiment of the optical film of the invention, each second light-transmissive portion is a through hole 52 penetrating through the first light-transmissive portion 51 and being filled with air, and a refractive index of the first light-transmissive portion 51 is different from the refractive index of the air. A hole wall of the through hole 52 is an inclined surface 521 neither parallel nor perpendicular to the light incident surface 511 of the first light-transmissive portion 51. Two openings 522, 523 of the through hole 52 respectively are located on the light incident surface 511 and the light exit surface 512 of the first light-transmissive portion 51. Compared with the conventional wide viewing angle film filled with microsphere structures, this embodiment only needs to form the through holes 52 penetrating through the first light-transmissive portion 51 in the first light-transmissive portion 51, which can reduce process requirement and reduce material cost.

Furthermore, the through hole 52 is a tapered through hole, the large opening 523 of the through hole 52 is located on the light exit surface 512 of the first light-transmissive portion 51, and the small opening 522 is located on the light incident surface of the first light-transmissive portion 51.

Because the refractive index difference between the first light-transmissive portion 51 and the air in the through hole 52, in the light rays perpendicularly incident from the light incident surface 511, the light ray a is refracted when striking on the inclined surface 521 of the through hole 52, an exit angle of the light ray a is enlarged, and therefore the effect of wide viewing angle is achieved. Most of the light rays (e.g., light rays b) directly pass through the through hole 52 (i.e., pass through the through hole 52 from the two openings 522, 523 of the through hole 52) and the interval between neighboring through holes 52 and then perpendicularly exit from the light exit surface 512, so that the light rays b do not strike on the inclined surface 521 and thus perpendicularly exit from the light exit surface, the exit direction of the light rays b basically is not deflected and therefore they still perpendicularly exit from the light exits surface, which is beneficial to reduce image blurriness.

Of course, in other embodiment, each of the through holes may be filled with a transparent optical material having a refractive index different from that of the first light-transmissive portion. Each of the through holes may have other shape, for example, it is a through hole having a right angle trapezoidal cross-sectional shape, i.e., a through hole only has one-sided inclined surface, or the inclined surface of the through hole may be a curved surface instead.

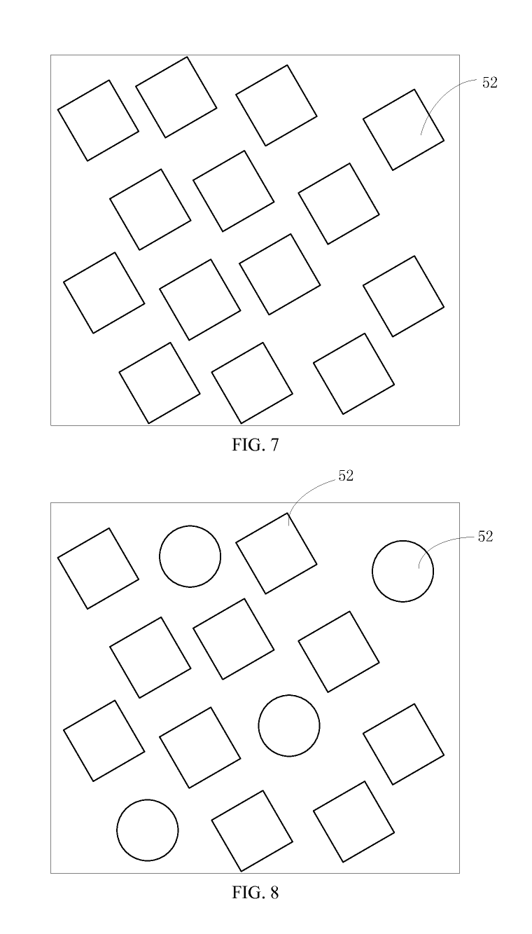

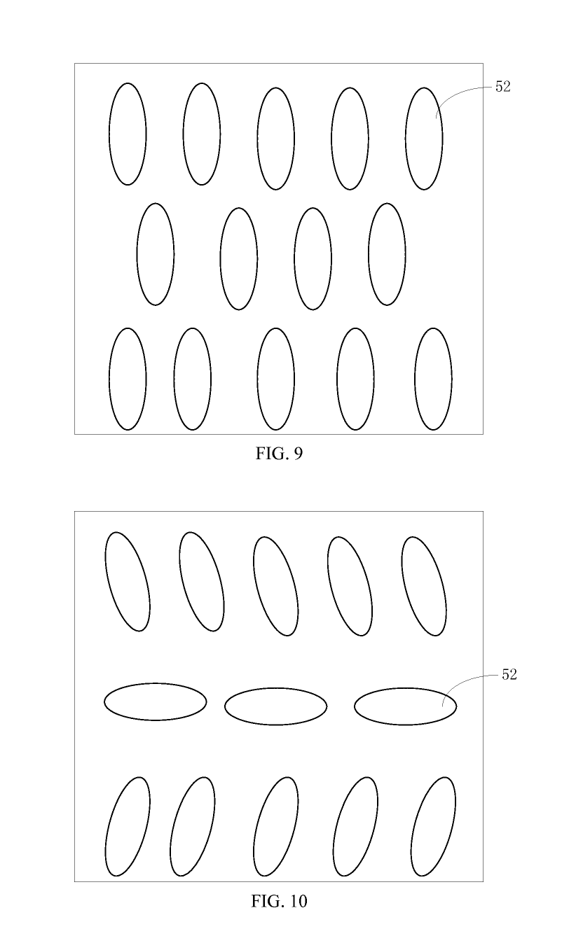

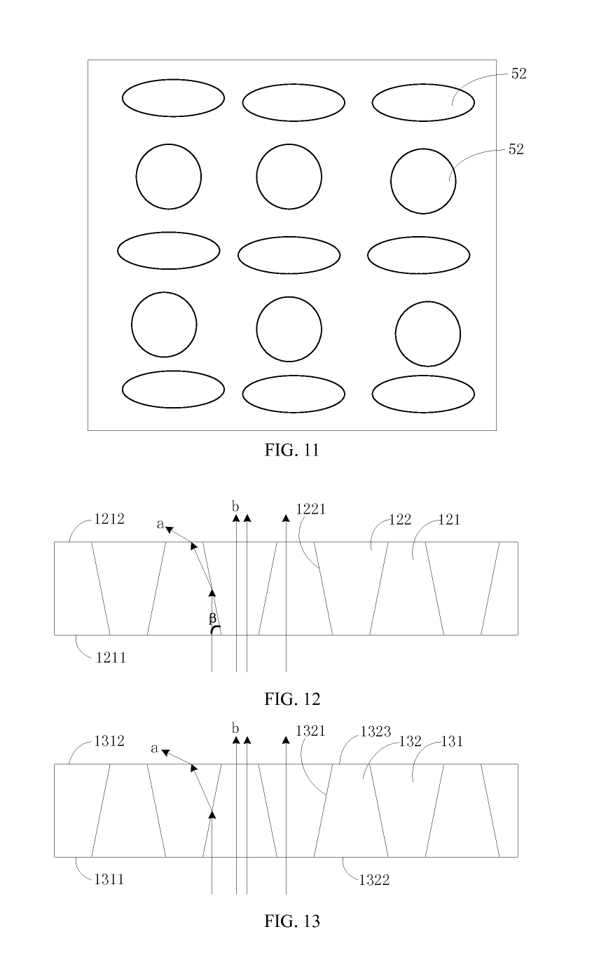

As shown in FIG. 5, all the through holes 52 have a same size and a same shape. The through holes 52 are square-shaped through holes and arranged in a matrix. In other embodiment, the through holes 52 may have different sizes and different shapes, i.e., shape, density and arrangement manner of each through hole 52 and a combination of different through holes can be adjusted according to actual requirement, for example, as shown in FIG. 7 through FIG. 11, the through hole 52 may be square, elliptical, circular, a combination of elliptical and circular, a combination of circular and square, and so on.

An average size of opening of the through holes 52 is in the range of 1 μm˜100μ, and of course, the average size of opening is not limited in the range and can be adjusted to be other size according to actual product.

Referring to FIG. 12, in an embodiment of the optical film of the invention, a refractive index of the first light-transmissive portion 121 is in the range of 1.3˜1.9 and thus greater than the refractive index of the air. Moreover, an intersection angle β between the inclined surface 1221 and the light incident surface 1211 is larger than a predetermined value, so that the part a of the light rays perpendicularly incident from the light incident surface 1211 has an incident angle on the inclined surface 1221 larger than a critical angel of total reflection, the light ray a is totally reflected on the inclined surface 1221 when striking on the inclined surface 1221, the effect of wide viewing angle is further improved.

The predetermined value can be determined according to the refractive index of the first light-transmissive portion 121 and thus is not limited herein. The incident angle of the light ray a perpendicularly incident from the light incident surface 1211 on the inclined surface 1221 is relevant with the intersection angle β between the inclined surface 1221 and the light incident surface 1211, by changing the intersection angle β between the inclined surface 1221 of the tapered through hole 122 and the light incident surface 1211, the incident angle of the light ray a on the inclined surface 1221 can be changed correspondingly. The incident angle of the light ray a on the inclined surface 1221 is an intersection angle between the light ray a and the normal line perpendicular to the inclined surface 1221. The smaller the intersection angle β is, the smaller the incident angle of the light ray a on the inclined surface 1221 is. Accordingly, in actual application, it may be that firstly determining the critical angle of total reflection according to the refractive index of the first light-transmissive portion 121 and then setting the size of the intersection angle β according to the critical angle to make the incident angle of the light ray a on the inclined surface 1221 to be larger than the critical angle of total reflection.

In addition, the larger the refractive index of the first light-transmissive portion 121 is, the smaller the critical angle of total reflection on the inclined surface 1221 is, and the total reflection more easily occurs. For example, when the refractive index of the first light-transmissive portion 121 is 1.5, the critical angle of total reflection is 40°, and at this situation, the total reflection would occur when the incident angle of the light ray a on the inclined surface 1221 larger than 40°. When the refractive index of the first light-transmissive portion is 1.6, the critical angle of total reflection is about 37°, and at this situation, the total reflection would occur when the incident angle of the light ray a on the inclined surface 1221 larger than 37°.

Of course, the refractive index of the first light-transmissive portion 121 may be in other range, and can be selected according to the refractive index of the second light-transmissive portions. For example, when the refractive index of the second light-transmissive portions is 1.5, the first light-transmissive portion 121 selects a material having a refractive index larger than 1.5, as long as the total reflection condition can be met.

Referring to FIG. 13, in still another embodiment of the optical film of the invention, the small opening 1323 of the tapered through hole 132 of the second light-transmissive portion may be located on the light exit surface 1312 of a first light-transmissive portion 131 instead, and the large opening 1322 is located on the light incident surface 1311 of the first light-transmissive portion 131. At this situation, in light rays perpendicularly incident from the light incident surface 1311, the part a of light rays entering into the through hole 132 strikes on the inclined surface 1321, due to the refractive index difference between the first light-transmissive portion 131 and the air in the through hole 132, the light ray a is deflected on the inclined surface 1321, an exit angle thereof is enlarged and it no longer perpendicularly exits from the light exit surface 1312, the purpose of enlarging viewing angle is achieved. The other perpendicularly incident light rays b directly pass through the through hole 132 and the interval between neighboring through holes 132 but do not strike on the inclined surface 1321, the light rays b are not deflected and perpendicularly exit from the light exit surface 1312, which is beneficial to reduce image blurriness.

Of course, in other embodiment, for the through holes 132 as shown in FIG. 13, it may be that making the light ray a to non-perpendicularly exit from the light exit surface 1312 by total reflection on the inclined surface 1321. Most of solid materials have refractive indexes larger than the refractive index of the air, in order to make the light ray a to more easily to generate total reflection on the inclined surface 1321, an optically transparent material having a refractive index larger than that of the first light-transmissive portion 131 may be filled in the through holes 132, and by setting the intersection angle between the inclined surface 1321 and the light incident surface 1311 to make the incident angle of the light ray a on the inclined surface 1321 be larger than the critical angle of total reflection, the condition of the light ray a generating total reflection on the inclined surface 1321 can be met.

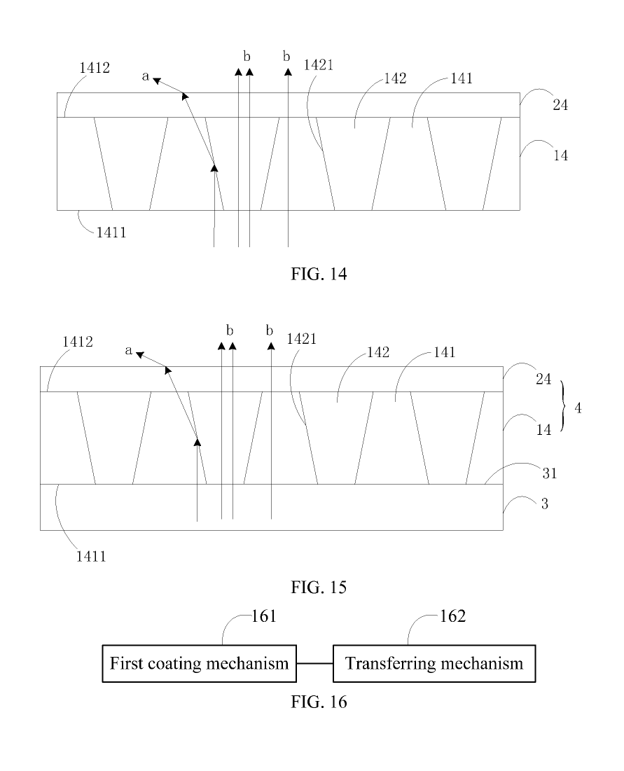

Referring to FIG. 14, in still another embodiment of the optical film of the invention, the optical film further includes a base layer 24 besides the optical layer 14. A material of the base layer 24 may be an optically transparent organic material, e.g., PET, TAC or organic glass PMMA and so on, a refractive index thereof may be the same as that of the first light-transmissive portion 141 of the optical layer 14. In this embodiment, the base layer 24 and the first light-transmissive portion 141 have the same refractive index, and a thickness of the base layer 24 is in the range of 5 μm˜100 μm, for example is 10 μm, 20 μm or 35 μm. Of course, the refractive index of the base layer 24 may be different from that of the first light-transmissive portion 141. When the base layer 24 and the first light-transmissive portion 141 have different refractive indexes, light rays will be refracted again at the interface between the base layer 24 and the first light-transmissive portion 14, which is further beneficial to enlarge viewing angle.

The base layer 24 is disposed on the light exit surface 1412 of the first light-transmissive portion 141 and is bonded with the light exit surface 1412 together by adhesive. In this embodiment, each second light-transmissive portion is a tapered through hole 142 penetrating through the first light-transmissive portion 141 and being filled with air, the hole wall of each through hole 142 is an inclined surface 1421 neither parallel nor perpendicular to the light incident surface 1411, and neighboring through holes 142 have an interval existed therebetween. A refractive index of the first light-transmissive portion 141 is greater than the refractive index of the air. A large opening of each through hole 142 is on the light exit surface 1412 of the first light-transmissive portion 141, and a small opening of the through hole 142 is located on the light incident surface 1411 of the first light-transmissive portion 141. An intersection angle between the inclined surface 1421 and the light incident surface 1411 is larger than a predetermined value, so that the light ray a perpendicularly incident from the light incident surface 1411 will generate total reflection on the inclined surface 1421. The light ray a passes through the base layer 24 after total reflection and then generates a secondary refraction at the interface between the base layer 24 and the external air and exits.

By making the light ray a to generate total reflection on the inclined surface 1421 so as to change the exit direction of the light ray a, the exit angle is enlarged when the light ray a exits from the light exit surface 1412, it no longer perpendicularly exits from the light exit surface 1412, so that a better effect of wide viewing angle can be obtained. Moreover, because each of the second light-transmissive portion is the through hole 142 penetrating through the first light-transmissive portion 141 and neighboring second light-transmissive portions have an interval existed therebetween, the light rays b perpendicularly incident from the light incident surface 1411 will pass through the through hole 142 and the interval between neighboring through holes 142 but do not strike on the inclined surface 1421, the exit direction thereof is not changed and thus they perpendicularly exit from the light exit surface 1412, which is beneficial to improve contrast and reduce image whitened whiling reducing image blurriness.

Referring to FIG. 15, in an embodiment of a display device of the invention, the display device includes a display screen 3 and an optical film 4. The optical film 4 is the optical film in any one of the above embodiments.

Taking the optical film as shown in FIG. 14 as an example, when the optical film 4 is applied onto the display screen 3, the light incident surface 1411 of the first light-transmissive portion 141 in the optical film 4 is bonded with a display surface 31 of the display screen 4 by adhesive, so as to receive image light rays from the display screen 3. Under the effect of the second light-transmissive portions 142 in the optical film 4, the image light ray a perpendicularly incident from the light incident surface 1411 strikes on the inclined surface 1421 and then non-perpendicularly exits from the light exit surface 1412 to thereby enlarge viewing angle, the image light rays b perpendicularly incident from the light incident surface 1411 do not strike on the inclined surface 1421 and therefore perpendicularly exit from the light exit surface 1512, image blurriness is reduced.

Referring to FIG. 16, in an embodiment of a manufacturing equipment of an optical film of the invention, the manufacturing equipment includes a first coating mechanism 161 and a transferring mechanism 162. The first coating mechanism 161 is configured (i.e., structured and arranged) for coating a transparent material on a release film to form a first light-transmissive portion of an optical layer. The first light-transmissive portion includes a light incident surface and a light exit surface. The release film only is for protection and thus is peeled off from the optical film after being manufactured so as to avoid the impact on light rays. The transferring mechanism 162 is configured for forming a plurality of second light-transmissive portions in the first light-transmissive portion to thereby form the optical layer. A refractive index of the first light-transmissive portion is different from that of the second light-transmissive portions, a contact surface of each second light-transmissive portion with the first light-transmissive portion at least include an inclined surface neither parallel nor perpendicular to the light incident surface of the first light-transmissive portion, and at least a part of light rays perpendicularly incident from the light incident surface do not strike on the inclined surface and exits from the light exit surface. Under the effect of the inclined surface, the light ray perpendicularly incident from the light incident surface and striking on the inclined surface will be deflected, the exit direction of the light ray is changed, the exit angle is enlarged, the light ray originally perpendicularly exited from the light exit surface will exit from the light exit surface in a manner of non-perpendicular to the light exit surface, the purpose of enlarging viewing angle can be achieved consequently.

In addition, at least a part of the light rays perpendicularly incident from the light incident surface does not strike on the inclined surface, the exit direction thereof is not changed and thus it will perpendicularly exit from the light exit surface, and therefore image blurriness can be reduced.

When forming the second light-transmissive portions, by making neighboring second light-transmissive portions to have an interval existed therebetween or the contact surface of each second light-transmissive portion with the first light-transmissive portion to have two opposite parallel surfaces parallel to the light incident surface of the first light-transmissive portion, a part of light rays perpendicularly incident from the light incident surface may directly pass through the interval between neighboring second light-transmissive portions and then exit from the light exit surface, or may pass through the two parallel surfaces of second light-transmissive portion and then exit from the light exit surface, so that the part of the light rays perpendicularly incident from the light incident surface would not strike on the inclined surface of the first light-transmissive portion, the exit direction of the part of the light rays would not be deflected and therefore it can perpendicularly exit from the light exit surface.

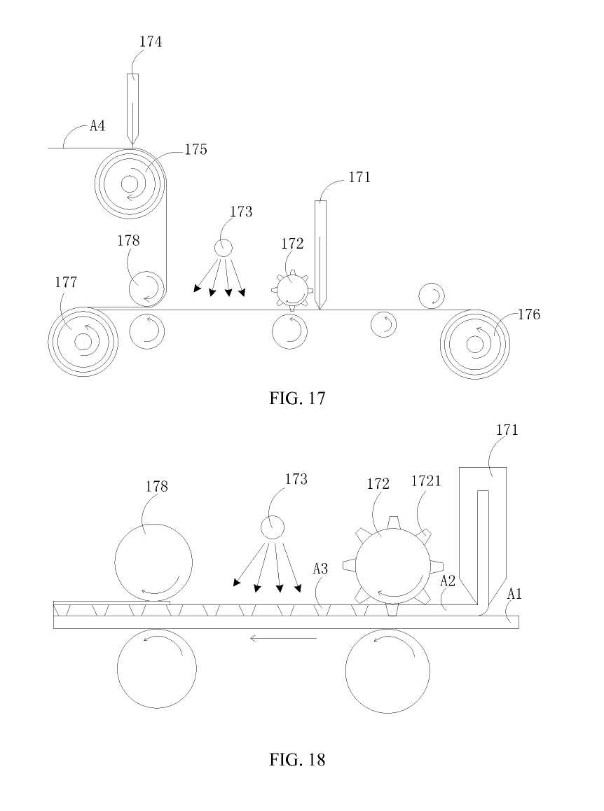

Referring to FIG. 17 and FIG. 18, in another embodiment of the manufacturing equipment of an optical film of the invention, a structure transferring method is adopted to form second light-transmissive portions in a first light-transmissive portion. In particular, the manufacturing equipment includes a first coating mechanism 171, a roller 172, a curing mechanism 173, a second coating mechanism 174, a base layer transportation mechanism 175, a first rotation shaft 176, a second rotation shaft 177 and a third rotation shaft 178. The second light-transmissive portions are through holes penetrating through the first light-transmissive portion. The roller 172 is used as a transferring mechanism of the manufacturing mechanism and configured for forming the through holes in the first light-transmissive portion.

A release film A1 is used as a transportation belt and configured for supporting the optical film during the process of manufacturing the optical film and playing a protective role. The release film A1 is transported from the first rotation shaft 176 to the second rotation shaft 177. The first coating mechanism 171, the roller 172, the curing mechanism 173, the second coating mechanism 174, the base layer transportation mechanism 175 and the third rotation shaft 178 are located between the first rotation shaft 176 and the second rotation shaft 177.

More specifically, during the manufacturing process, a transport direction of the optical film is from the first rotation shaft 176 to the second rotation shaft 177. In the transport direction of the optical film, the first coating mechanism 171 is located behind the first rotation shaft 176 and configured for coating a transparent optical material on the release film. The transparent optical material may be a PET film material or an organic glass, and so on and used for forming a first light-transmissive portion A2 of an optical layer of the optical film. The roller 172 is located behind the first coating mechanism 171 and has a plurality of protrusions 1721 on a surface thereof. When the first light-transmissive portion A2 of the optical layer is transported to the roller 172, the protrusions 1721 on the roller 172 squeeze into the first light-transmissive portion A2 from the light exit surface of the first light-transmissive portion A2 and penetrate through the light incident surface of the first light-transmissive portion A2 so as to form through holes A3 in the first light-transmissive portion A2 having a same shape and a same size as the protrusions 1721 and thereby the second light-transmissive portions are formed.

A contact surface of each protrusion 1721 with the first light-transmissive portion A2 is neither parallel nor perpendicular to the light incident surface of the first light-transmissive portion A2, so that a hole wall of each formed through hole A3 is neither parallel nor perpendicular to the light incident surface of the first light-transmissive portion A2 and thereby the inclined surface of each second light-transmissive portion is formed.

Furthermore, each protrusion 1721 is tapered, and an end thereof near the surface of the roller 172 is larger than another end thereof away from the surface of the roller 172. When the first light-transmissive portion A2 is transported to the roller 172, the small end of the protrusion 1721 squeezes into the first light-transmissive portion A2 from the light exit surface of the first light-transmissive portion A2 and penetrates through the light incident surface of the first light-transmissive portion A2, and thereby forming a tapered through hole A3 in the first light-transmissive portion A2. The large opening of the tapered through hole A3 is located on the light exit surface of the first light-transmissive portion A2, and the small opening of the tapered through hole A3 is located on the light incident surface of the first light-transmissive portion A2. Accordingly, by transferring the structure of the protrusion 1721 into the first light-transmissive portion A2, the second light-transmissive portions are formed in the first light-transmissive portion A2.

The curing mechanism 173 is disposed behind the roller 172 and configured for curing the first light-transmissive portion A2 formed with the through holes A3 to thereby obtain the optical layer of the optical film. The curing mechanism 173 is a UV (ultraviolet) light curing mechanism and illuminates the first light-transmissive portion A2 with UV light to cure the first light-transmissive portion A2. In other embodiment, the curing mechanism 173 may be a heating mechanism, i.e., curing the first light-transmissive portion A2 by heating.

The base layer transportation mechanism 175 is disposed behind the curing mechanism 173 and can be implemented by a rotation shaft. The base layer transportation mechanism 175 is configured for transporting a base layer A4 onto the cured first light-transmissive portion A2 to form the base layer A4 on the light exit surface of the first light-transmissive portion A2. A material of the base layer A4 is the same as that of the first light-transmissive portion A2, and both are a transparent optical material e.g., a PET film layer or an organic glass. A refractive index of the base layer A4 is the same as that of the first light-transmissive portion A2. Of course, in other embodiment, the refractive index of the base layer may be different from that of the first light-transmissive portion A2.

The second coating mechanism 174 is disposed above the base layer transportation mechanism 175 and configured for coating a pressure-sensitive adhesive on a surface of the base layer A4 going through the base layer transportation mechanism 175 to bond the base layer A4 with the first light-transmissive portion A2 together by the pressure-sensitive adhesive during the base layer A4 is transported onto the first light-transmissive portion A2. In addition, the third rotation shaft 178 is disposed a position of bonding the base layer A4 with the first light-transmissive portion A2 and configured for squeezing the bonded base layer A4 and first light-transmissive portion A2 to tightly press both of them together and thereby obtain the optical film.

In other embodiment, the second coating mechanism 174 can be omitted, and at this situation the base layer A4 and the first light-transmissive portion A2 are bonded together by their own lamination. In addition, in an alternative embodiment, the transferring mechanism may be a mask combination, i.e., forming the optical layer by exposure and development process and so on.

By the manufacturing equipment of this embodiment, the optical layer is formed after the raw material coating (i.e., the process of coating the first light-transmissive portion), structure transferring (i.e., the process of forming the second light-transmissive portions) and UV curing, the base layer and the optical layer then are bonded together by the pressure-sensitive adhesive, the whole manufacturing process is a continuous production process and therefore can greatly improve productivity. Moreover, compared with the exposure and development process, no chemical waste and waste gas are generated, and therefore is more environmentally friendly.

Of course, in other embodiment, the end of each protrusion of the roller near the surface of the roller may be smaller than the other end of the protrusion away from the surface of the roller, so that the large opening of the formed through hole is located on the light incident surface and the small opening of the formed through hole is located on the light exit surface; and each protrusion may be other shaped e.g., a right angle trapezoid.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An optical film comprising an optical layer and a base layer, the optical layer comprising:
a first light-transmissive portion having a light incident surface and a light exit surface parallel with each other;
a plurality of second light-transmissive portions distributed in the first light-transmissive portion;
wherein the plurality of light-transmissive portions are through holes penetrating through the first light-transmissive portion and being filled with air, a hole wall of each of the through holes is an inclined surface neither parallel nor perpendicular to the light incident surface of the first light-transmissive portion, two openings of each of the through holes respectively are located on the light incident surface and the light exit surface of the first light-transmissive portion and thereby at least a part of light rays perpendicularly incident from the light incident surface passes through the through hole and exits from the light exit surface so that the at least a part of the light rays perpendicularly incident from the light incident surface does not strike on the inclined surface and exits from the light exit surface;
wherein a refractive index of the first light-transmissive portion is different from a refractive index of the air;
wherein the base layer is disposed on the light exit surface of the first light-transmissive portion, and a refractive index of the base layer is the same as the refractive index of the first light-transmissive portion.

2. The optical film as claimed in claim 1, wherein each of the through holes is a tapered through hole, the large one of the two openings of the tapered through hole is located on the light exit surface of the first light-transmissive portion, and the small one of the two openings of the tapered through hole is located on the light incident surface of the first light-transmissive portion.

3. The optical film as claimed in claim 2, wherein the refractive index of the first light-transmissive portion is greater than the refractive index of the air.

4. A display device comprising a display screen and an optical film, the optical film comprising an optical layer; the optical layer comprising:
a first light-transmissive portion, having a light incident surface and a light exit surface parallel with each other, wherein the light incident surface of the first light-transmissive portion is attached to a display surface of the display screen to receive image light rays of the display screen;
a plurality of second light-transmissive portions, distributed in the first light-transmissive portion;
wherein the first light-transmissive portion and the plurality of second light-transmissive portions have different refractive indexes, a contact surface of each of the plurality of second light-transmissive portions with the first light-transmissive portion comprises an inclined surface neither parallel nor perpendicular to the light incident surface of the first light-transmissive portion, and at least a part of light rays perpendicularly incident from the light incident surface does not strike on the inclined surface and exits from the light exit surface.

5. The display device as claimed in claim 4, wherein each of the plurality of second light-transmissive portions are through holes penetrating through the first light-transmissive portion and being filled with air, a hole wall of each of the through holes is the inclined surface neither parallel nor perpendicular to the light incident surface of the first light-transmissive portion, two openings of each of the through holes respectively are located on the light incident surface and the light exit surface of the first light-transmissive portion and thereby the at least a part of the light rays perpendicularly incident from the light incident surface passes through the through hole and exits from the light exit surface so that the at least a part of the light rays perpendicularly incident from the light incident surface does not strike on the inclined surface and exits from the light exit surface;
the refractive index of the first light-transmissive portion is different from the refractive index of the air.

6. The display device as claimed in claim 5, wherein each of the through holes is a tapered through hole, the large one of the two openings of the tapered through hole is located on the light exit surface of the first light-transmissive portion, and the small one of the two openings of the tapered through hole is located on the light incident surface of the first light-transmissive portion.

7. The display device as claimed in claim 6, wherein the refractive index of the first light-transmissive portion is greater than the refractive index of the air.

8. The display device as claimed in claim 4, wherein the optical film further comprises a base layer, the base layer is disposed on the light exit surface of the first light-transmissive portion, a refractive index of the base layer is the same as the refractive index of the first light-transmissive portion.

9. A manufacturing equipment of an optical film, comprising:
a first coating mechanism, configured for forming a first light-transmissive portion of an optical layer; wherein the first light-transmissive portion comprises a light incident surface and a light exit surface parallel with each other;
a transferring mechanism, configured for forming a plurality of second light-transmissive portions in the first light-transmissive portion to thereby form the optical layer of the optical film; wherein the first light-transmissive portion and the plurality of second light-transmissive portions have different refractive indexes, a contact surface of each of the plurality of second light-transmissive portions with the first light-transmissive portion comprises an inclined surface neither parallel nor perpendicular to the light incident surface of the first light-transmissive portion, and at least a part of light rays perpendicularly incident from the light incident surface does not strike on the inclined surface and exits from the light exit surface.

10. The manufacturing equipment as claimed in claim 9, wherein the transferring mechanism is a roller having a plurality of protrusions formed on a surface thereof, the roller is disposed behind the first coating mechanism in a transport direction of the optical layer; during the first light-transmissive portion is transported to the roller, the plurality of protrusions squeeze into the first light-transmissive portion from the light exit surface of the first light-transmissive portion and penetrate through the light incident surface of the first light-transmissive portion to form through holes having the same size and the same shape as the plurality of protrusions in the first light-transmissive portion and thereby form the plurality of second light-transmissive portions; when any one of the plurality of protrusions squeezes into the first light-transmissive portion, a contact surface of the protrusion with the first light-transmissive portion is neither parallel nor perpendicular to the light incident surface of the first light-transmissive portion.

11. The manufacturing equipment as claimed in claim 10, wherein each of the plurality of protrusions is tapered, an end of the protrusion near the surface of the roller is larger than another end of the protrusion away from the surface of the roller; during the first light-transmissive portion is transported to the roller, the small end of the protrusion squeezes into the first light-transmissive portion from the light exit surface of the first light-transmissive portion and penetrates through the light incident surface of the first light-transmissive portion.

12. The manufacturing equipment as claimed in claim 11, wherein the manufacturing equipment further comprises a curing mechanism and a base layer transportation mechanism;
the curing mechanism is disposed behind the roller in the transport direction of the optical layer and configured for curing the optical layer;
the base layer transportation mechanism is disposed behind the curing mechanism in the transport direction of the optical layer and configured for transporting a base layer of the optical film onto the light exit surface of the first light-transmissive portion to thereby form the base layer of the optical film on the light exit surface; a refractive index of the base layer is the same as the refractive index of the first light-transmissive portion.
